(19) United States
(12) Patent Application Publication
(10) Pub. No.: US 2003/0178804 A1
(43) Pub. Date: Sep. 25, 2003

(54) ANTI-WEAR STRIP EQUIPPED WHEEL SEAT OF SKATEBOARD

(76) Inventor: Chien-Hua Lee, Taipei Hsien (TW)

Correspondence Address: SUPREME PATENT SERVICES, POST OFFICE BOX 2339, SARATOGA, CA, 95070, US

(21) Appl. No.: 10/104,831

(22) Filed: Mar. 22, 2002

(51) Int. Cl. B62M 1/00

(52) U.S. Cl. 280/87.042

(57) ABSTRACT

An anti-wear strip equipped wheel seat comprises a main body, an axle, and anti-wear strip, in which the anti-wear strip is a [symbol] -shaped plate made of a wear-resist material, having an arcuate recess in each of two end edges thereof for mounting the axle directly. The axle and the anti-wear strip are invested stably in the main body except an anti-wear face at the bottom edge of the anti-wear strip and both ends of the axle so that the bottom edge of wheel seat could be protected against wearing, particularly for a technical trick performance or race.

### FIELD OF THE INVENTION

The present invention generally relates to a strip for a wheel seat, and more specifically to an anti-wear strip equipped wheel seat.

### BACKGROUND OF THE INVENTION

A skateboarding veteran in these days is expected to play some peculiar tricks other than the routines, such as skate the wheel seat of a skateboard along a transverse rail to result in a ruptured or worn-out wheel seat sooner or later. Thus, the wheel seat has to be replaced from time to time in order to avoid possible dangers. However, unfortunately, most of the skateboard makers do not care much about this point or try to make improvements.

### SUMMARY OF THE INVENTION

The primary objective of this invention is to provide an anti-wear strip equipped wheel seat comprising: a main body, an axle, and anti-wear strip, in which the anti-wear strip is a [symbol] -shaped plate made of a wear-resist material, having an arcuate recess in each of two end edges thereof for mounting the axle directly. The axle and the anti-wear strip are invested stably in the main body except an anti-wear face at the bottom edge of the anti-wear strip and both ends of the axle so that the bottom edge of wheel seat could be protected against wearing, particularly for a technical trick performance or race.

In short, the merits of this invention might be summarized in the following:

(1) The lifetime or sightliness of a wheel seat is prolonged or promoted by using this invention.

(2) The anti-wear strip is stably fixed in the main body by taking advantage of the actuate recess at both ends of the anti-wear strip for waiving unnecessary worry of detachment by an external impact.

(3) The axle can be loaded easily during the fabrication process and the molding cost and complicatedness might be lowered or simplified with the favorable arcuate recesses.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a schematic perspective view of this invention;

FIG. 2 is a schematic view of this invention in three dimensions;

FIG. 3 is a cutaway sectional view showing the assembly of a wheel seat of this invention;

FIG. 4 is a cutaway sectional view showing an anti-wear strip of this invention;

FIG. 5 is a schematic view showing an embodiment (A) of this invention; and

FIG. 6 is a schematic view showing another embodiment (B) of this invention.

### DETAILED DESCRIPTION OF THE INVENTION

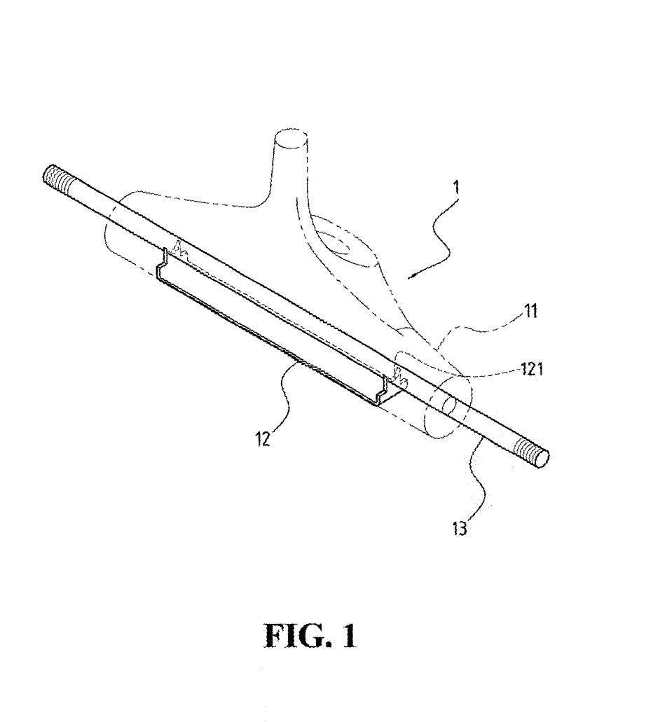

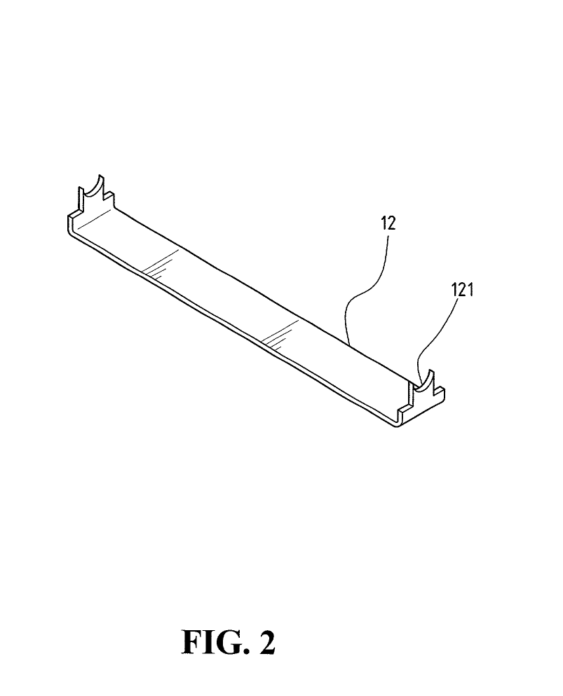

As illustrated in FIGS. 1 and 2, a wheel seat (1) of skateboard is composed of a main body (11), an axle (13), and an anti-wear strip (12). Both ends of the anti-wear strip is bent upwardly to form a [symbol] -shaped longitudinal plate made of a wear-resist material, having an arcuate recess (121) in each of two end edges thereof matched in curvature with the outer diameter of the axle (13) such that the axle (13) can lie directly on those arcuate recesses (121) fitly. The axle (13) and the anti-wear strip (12) are then invested in the main body (11) except an anti-wear face (122) at the bottom edge of the anti-wear strip (12) and two ends of the axle (13).

In formation of the entire wheel seat (1), the procedure is to fix the anti-wear strip (12) in a mold firstly; then lay the axle (13) on the top edge of the anti-wear strip (12); and cast it in a liquefied metallic material to form the main body (11) and have the axle (13) and the anti-wear strip invested therein. By taking advantage of the arcuate recess (121) designed in the anti-wear strip (12) for the axle (13) to stride, in addition to decrement of the molding cost, it is possible to have the anti-wear strip (12) and the main body (11) consolidated together without worry of detachment by an external powerful impact. Moreover, the bottom edge of the wheel seat (1) can be saved from getting worn-out when rubbing against earth or rails in a race or performance so that the lifetime or sightliness thereof can be prolonged or maintained.

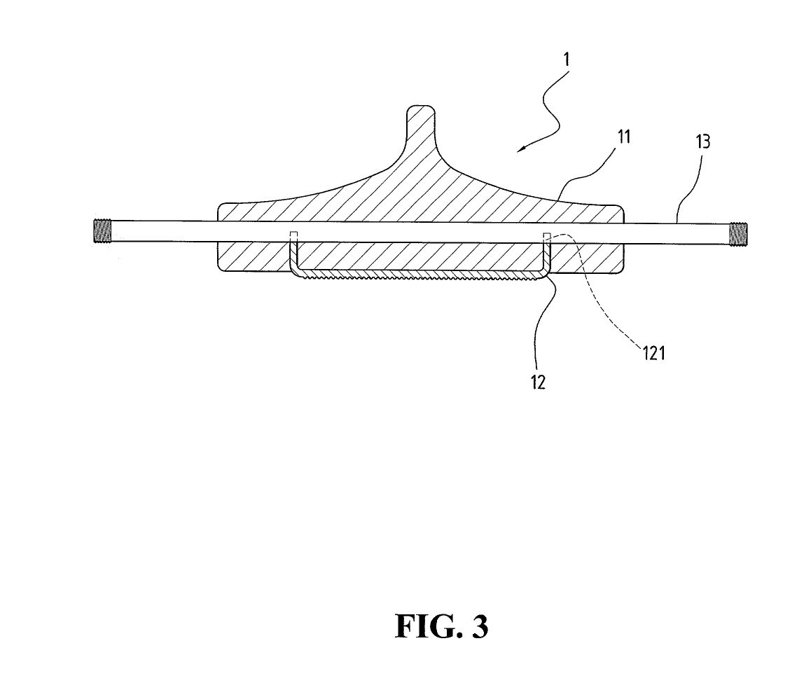

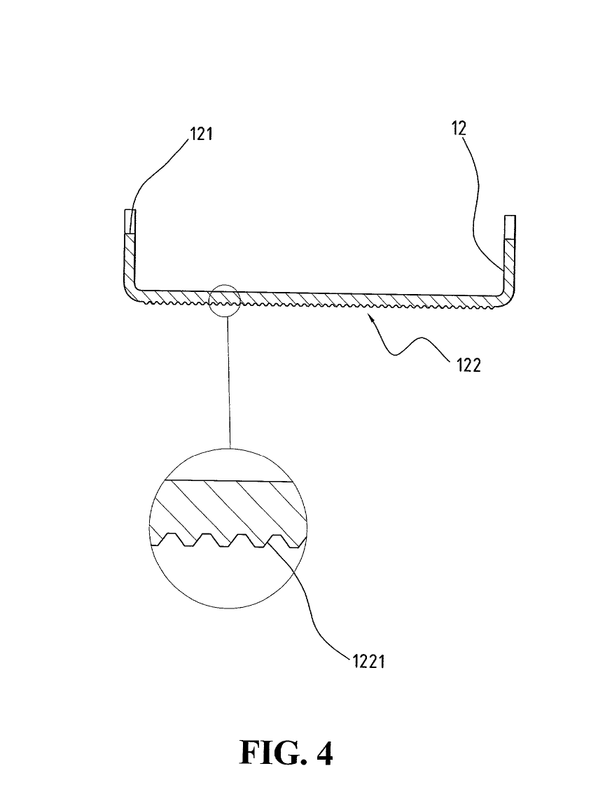

Referring to FIGS. 3 and 4, both ends of the anti-wear strip (12) is bent upwardly to form a [symbol] -shaped longitudinal plate made of a wear-resist material, having an arcuate recess (121) in each of two end edges thereof so as to accommodate and support an axle (13) directly. The bottom edge of the anti-wear strip (12) is substantially an anti-wear face (122) protruded from a main body (11) about 1 mm thick after the anti-wear strip (12) is invested in the main body (11). Furthermore, a numerosity of slip-resist lumps (1221) shaped in cones, spheres, or pillars could be formed on the anti-wear face (122).

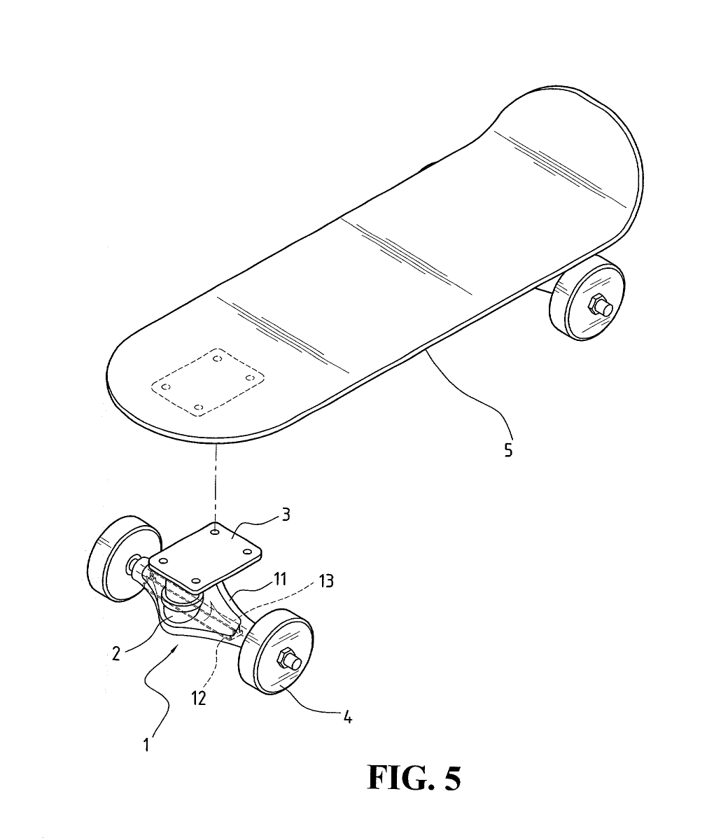

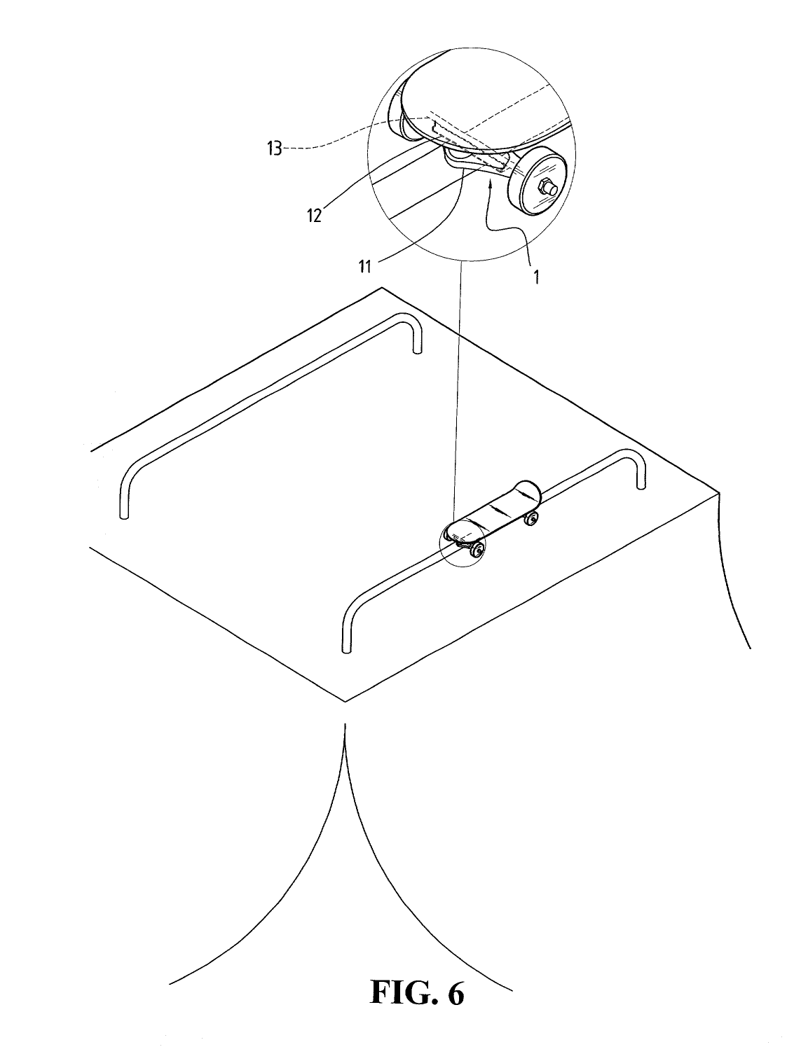

As indicated in embodiment (A) and (B) of FIGS. 5 and 6, the wheel seat (1) is composed of a main body (11), an axle (13), and an anti-wear strip (12). A wheel (4) is mounted on respective ends of the axle (13) protruding laterally over the main body (11) and a shock absorber (2) and a securing top plate (3) are disposed at a front edge and a top edge respectively of the main body (11) to thereby fix the wheel seat (1) to a skateboard (5).

The anti-wear strip of this invention is particularly effective for preventing the wheel seat from wearing, which is now taken as a narrow skateboard for skating along a handrail of staircase transversely, for example.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. An anti-wear strip equipped wheel seat of skateboard, comprising a main body, an axle, and an anti-wear strip, in which said anti-wear strip is a [symbol] -shaped plate made of a wear-resist material, in which an arcuate recess is formed at each of two ends of said anti-wear strip for supporting said axle, said axle and anti-wear strip being invested in said main body stably except an anti-wear face at the bottom edge of said anti-wear strip and two ends of said axle exposed to the air.

2. The wheel seat according to claim 1, in which said anti-wear face protrudes outwardly over said main body about 1 mm thick.

3. The wheel seat according to claim 1, in which a numerosity of slip-resist lumps is formed on said anti-wear face.

4. The wheel seat according to claim 3, in which said slip-resist lumps are made in form of cones, spheres, pillars, etc.
